(19) United States
(12) Patent Application Publication
(10) Pub. No.: US 2021/0309201 A1
(43) Pub. Date: Oct. 7, 2021

(54) ASSEMBLY FOR AN ELECTROMECHANICAL BRAKE BOOSTER OF A VEHICLE BRAKING SYSTEM, BRAKE BOOSTER WITH SUCH AN ASSEMBLY, AND VEHICLE BRAKING SYSTEM WITH SUCH AN ASSEMBLY

(71) Applicant: ZF Active Safety GmbH, Koblenz (DE)

(72) Inventor: Martin Struschka, Braubach (DE)

(21) Appl. No.: 17/218,452

(22) Filed: Mar. 31, 2021

(30) Foreign Application Priority Data
Apr. 3, 2020 (DE) 102020109449.3

(51) Int. Cl. B60T 13/74; B60T 7/12; B60T 17/18

(52) U.S. Cl. CPC B60T 13/745; B60T 7/06; B60T 17/18; B60T 7/12

(57) ABSTRACT

The present disclosure concerns an assembly (100) for an electromechanical brake booster (200) of a vehicle braking system (1000). The assembly comprises an actuating member (120) which can be loaded with a first actuating force generated by means of a brake pedal, and a housing (160, 160a) in which the actuating member (120) is received, wherein the housing (160, 160a) can be loaded with a second actuating force generated electromechanically. Furthermore, the assembly (100) comprises an output element (150) extending away from the housing (160, 160a). Said element is configured for transmitting the first and second actuating forces to a brake cylinder (300) of the vehicle braking system (1000). Furthermore, an elastically deformable transmission element (140) is provided which is arranged to transmit force in a brake application direction between the actuating member (120) and the housing (160, 160a) on one side and the output element (150) on the other, and is configured to receive the first actuating force from the actuating member (120) and the second actuating force from the housing (160, 160a) and transmit these to the output element (150). According to the present disclosure, a support (160, 160a) that is rigidly arranged on the housing is provided for a portion of the output element (150), wherein the supported or supportable portion of the output element (150) is arranged between the support (180, 180a) on one side and the transmission element (140) on the other.

### RELATED APPLICATIONS

The present invention claims priority from 102020109449.3, filed 3 Apr. 2020, the entirety of which is incorporated herein by reference.

### TECHNICAL FIELD

The present disclosure generally concerns an assembly for an electromechanical brake booster of a vehicle braking system. In concrete terms, aspects are described which are connected with the reduction of an undesirable angular deflection of an output element of the assembly during operation of the brake booster.

### BACKGROUND

Known electromechanical brake boosters of a vehicle braking system are provided for example to amplify an actuating force generated by a driver via the brake pedal, so as to reduce the force application by the driver for a braking process. This is frequently achieved using an electrically operable actuator which, on operation, causes an adjustment movement of one or more components, which increase or generate a brake pressure in a brake cylinder. Known electromechanical brake boosters may also build up a brake pressure by operation of the actuator alone and independently of actuation of the brake pedal, for example in an autonomous driving mode.

Such electromechanical brake boosters comprise a housing which can be loaded with an actuating force by the actuator and is mounted movably. Both the actuating force generated by the actuator and the actuating force generated by the driver are received by an elastically deformable transmission element (e.g. a reaction disc) arranged in or on the housing, and transmitted to an output element which in turn transmits the actuating forces to the vehicle braking system in order to initiate a braking process. The transmission element is typically arranged between an actuating member (which is loaded with an actuating force by the driver) and the housing on one side, and the output element on the other.

It has been observed that during operation of the brake booster, for example due to unevenness of the road surface or by jerky actuation of the brake pedal in emergency braking, an angular deviation can occur between the longitudinal axes of the components executing the adjustment movement, in particular between the longitudinal axis of the housing and that of the output element.

This angular deviation may lead to a unilateral loading and hence to an uneven deformation of the transmission element. In the worst case, the transmission element may be permanently damaged. Other damage, for example to bearing components may be attributed to these angular deviations.

### SUMMARY

The present disclosure is based on the object of indicating an assembly for an electromechanical brake booster of the vehicle braking system, which counters a damage of the elastically deformable transmission element and generally an angular deflection of the output element.

According to a first aspect, an assembly is provided for an electromechanical brake booster of a vehicle braking system. The assembly comprises an actuating member which can be loaded with a first actuating force generated by means of a brake pedal, and a housing in which the actuating member is received, wherein the housing can be loaded with a second actuating force generated electromechanically. Furthermore, the assembly comprises an output element extending away from the housing and configured for transmitting the first and second actuating forces to a brake cylinder of the vehicle braking system, and an elastically deformable transmission element which is arranged to transmit force in a brake application direction between the actuating member and the housing on one side and the output element on the other, and is configured to receive the first actuating force from the actuating member and the second actuating force from the housing and transmit these to the output element. According to the present disclosure, the assembly also comprises a support that is rigidly arranged on the housing for a portion of the output element, wherein the supported or supportable portion of the output element is arranged between the support on one side and the transmission element on the other.

The actuating member may be displaceable relative to the housing, namely in the brake application direction and in a direction opposite the brake application direction. The actuating member may be connected at its one end directly or indirectly (e.g. via an input rod) to the brake pedal, via which the driver can apply the first actuating force. The actuating member may in particular be displaced in the brake application direction by actuation of the brake pedal, and be returned to a rest position by means of the return force from a return spring and/or a brake cylinder. The actuating member may at its other end be configured to transmit the first actuating force to the transmission element. The actuating member may be configured as an actuation rod or actuation piston with substantially circular cross-section. The actuating member may furthermore be coupled to the housing, for example by means of correspondingly formed coupling elements. A displacement of the actuating member may also lead to a displacement of the housing.

The housing may be part of an actuator of the electromechanical brake booster. On electrical actuation of the actuator, the housing may be displaced in the brake application direction in order to actuate the vehicle braking system. The housing may also be coupled directly or indirectly to a pressure piston of the brake cylinder, so that a displacement of the housing leads to a displacement of the pressure cylinder and hence to a build-up of brake pressure. Furthermore, the housing may be coupled to the actuating member so that a displacement of the housing may also lead to a displacement of the actuating member.

The output element may be partially received inside the housing. For example, a first portion of the output element may protrude from the housing and into the brake cylinder of the vehicle braking system. A second portion of the output element (for example the supported or supportable portion) may be received in the housing at least in regions and be configured to receive the first and/or second actuating force. The supported or supportable portion of the output element may be configured to be or come into contact with the transmission element.

The transmission element may be formed as a disc (e.g. as a so-called reaction disc). The transmission element may have a radially outer face which can make contact with the housing in order to receive the second actuating force. The transmission element may furthermore have a radially inner face which may be configured to receive the first actuating force. In the supported state of the output element, such as on performance of the braking process, the transmission element may be or become elastically deformed for transmitting the first and/or second actuating force to the output element.

An angular deflection of the output element may be reduced or at least largely prevented by the support which is arranged rigidly on the housing, in that the supported or supportable portion of the output element may be locally fixed between the support on the one side and the transmission element on the other. This does not exclude that one or more further elements are arranged so as to transmit force between the supported or supportable portion of the output element and the support on one side and/or the transmission element on the other. The support is suitable for countering an angular deflection of the output element in that it is translationally displaceable substantially only parallel to the longitudinal axis of the housing. The force transmission in the assembly accordingly also takes place substantially evenly and along the longitudinal axis of the housing.

In a refinement, the support has an inner face arranged against the brake application direction and configured to be or come into contact with the supported or supportable portion of the output element. In particular while performing a braking process, the supported or supportable portion of the output element may be or come into contact with the inner face. The inner face may exert a force acting against the brake application direction on the supported or supportable portion of the output element, countering a forced leading to an angular deflection of the output element. At least a part portion of the inner face of the support may be arranged on the housing.

In any case, the support may be formed partially by a separate support component which is attached to the housing. The support component may be made of a rigid material such as steel or sheet metal. The support component may be attached to the housing by means of welding, in particular by means of ultrasound welding. The support component could also be attached to the housing by bolting or another fixing method.

In some embodiments, the support may at least partially form the limit of a receiver which receives (at least) the supported or supportable portion of the output element and the transmission element. In an exemplary embodiment, the receiver may be formed by a recess in the housing. The support may then extend at least partially beyond an end face of the housing in which the recess is molded. Alternatively, the transmission element and the supported or supportable portion of the output element may be arranged outside the housing. In this embodiment, the housing comprises for example an end face which faces the brake cylinder of the vehicle braking system and on which the support is arranged. In this embodiment, the supporting engages behind both the transmission element and the supported or supportable portion of the output element.

In a further refinement, the output element may comprise a shaft and a head which has a greater diameter than the shaft and is formed on an end of the shaft facing the housing. In this refinement, the supported or supportable portion may be formed on the head. The output element in this refinement may also comprise a transition portion arranged between the shaft and the head. The diameter of the transition portion may increase steplessly from the shaft to the head. The head and the shaft may be formed cylindrically along the longitudinal axis of the output element. At least portions of the head may be received in the receiver. In this refinement, the support may cooperate with a portion of the head of the output element facing away from the transmission element. In particular, this may be the end face of the head facing away from the transmission element. In this refinement, a force is exerted on the head of the output element by means of the rigid support, which force compensates for a force leading to an angular deflection of the output element (for example vibrations of the housing).

In one embodiment of the assembly, the support may be configured to support the output element such that in the supported state, a longitudinal axis of the output element and a longitudinal axis of the housing are oriented substantially parallel to each other. The supported state may for example be present during a braking process when the supported or supportable portion of the output element is brought into contact with the support. The support may then orient the output element so as to prevent a “kinking” of the output element relative to a longitudinal axis of the housing. In this embodiment, the support may furthermore be configured to support the output element such that, in the supported state, the elastically deformable transmission element is deformed substantially evenly over its extent perpendicular to the longitudinal axis of the housing.

According to a further embodiment of the assembly, the support may define a circular support face for the output element. The present disclosure is not however restricted to such a design of the support. Alternatively, the support may also take the form of support elements arranged spaced apart from each other along a circumferential direction of the shaft of the output element. Further suitable embodiments of the support are conceivable.

According to a second aspect, an electromechanical brake booster for a vehicle braking system is provided, which comprises an assembly according to the disclosure and an electric motor and gear mechanism for loading the housing with the second actuating force.

The electromechanical brake booster may be provided for amplifying the braking force provided by actuation of a brake pedal. The electromechanical brake booster may also be provided to provide a braking force independently of actuation of the brake pedal, for example in an autonomous or partially autonomous driving mode. The gear mechanism may be functionally provided between the electric motor and the housing of the assembly.

According to a third aspect, a vehicle braking system is provided which comprises an assembly according to the first aspect or a brake booster according to the second aspect. The vehicle braking system may be configured to be operated in an autonomous or partially autonomous driving mode.

### BRIEF DESCRIPTION OF THE FIGURES

Further aspects, details and advantages of the present disclosure arise from the following description of exemplary embodiments with reference to the figures. These show:

FIG. 1 schematically, a vehicle braking system with an electromechanical brake booster comprising an assembly according to the present disclosure;

FIG. 2A schematically, in a sectional side view, an assembly for an electromechanical brake booster according to the present disclosure with a support according to a first embodiment;

FIG. 2B the support according to the first embodiment, schematically in a top view; and

FIG. 3 schematically, in a sectional side view, an assembly for an electromechanical brake booster according to the present disclosure with a support according to a second embodiment.

### DETAILED DESCRIPTION

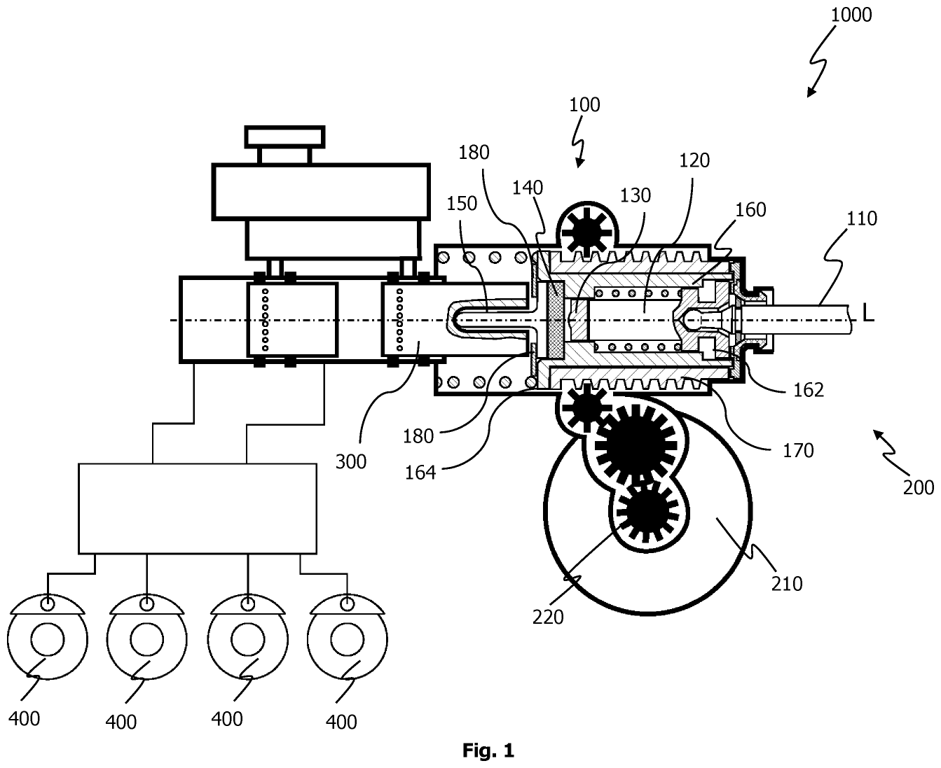

FIG. 1 shows a vehicle braking system 1000 with an assembly 100. The assembly 100 is here depicted as part of a brake booster 200. In the description below, firstly the structure and function of the vehicle braking system 1000 according to FIG. 1 will be described, as it may be used in exemplary embodiments.

The vehicle braking system 1000 according to FIG. 1 comprises the assembly 100, the brake booster 200, a brake cylinder 300, and four wheel brakes 400 hydraulically connected to the brake cylinder 300. The brake cylinder 300 in this exemplary embodiment is a brake master cylinder of the vehicle braking system 1000.

An input element 110 which can be loaded with a first actuating force, generated by the driver by means of a brake pedal (not shown), protrudes into the assembly 100. An actuating member 120 is coupled force-transmissively to the input element 110. The actuating element 120 is received in a recess 162 of a housing 160 of the assembly 100. The actuating member 120 is held inside the recess 162 so as to be movable along a housing longitudinal axis L. The first actuating force may be transmitted by the actuating member 120 via a sensing disc 130 to an elastically deformable, disc-like transmission element 140 (a so-called reaction disc).

The elastically deformable transmission element 140 is configured to receive the first actuating force from the actuating member 120 (via the sensing disc 130) and a second actuating force which is generated electromechanically and transmitted via the housing 160. Furthermore, the elastically deformable transmission element 140 is configured to transmit the first and second actuating forces to an output element 150. For the purpose of this force transmission, the transmission element 140 is elastically deformable along its entire extent perpendicular to the longitudinal axis L.

In the depiction of FIG. 1, the output element 150 is in contact with a side of the transmission element 140 facing away from the actuating member 120. The output element 150 is partially arranged inside the housing 160 and is configured to conduct an actuating force, transmitted by means of the elastic deformation of the transmission element 140, to a piston in the brake cylinder 300 of the vehicle braking system 1000. Thus a hydraulic braking pressure, which can be supplied to the wheel brakes 400 via valves, is generated in the brake cylinder 300.

Further details of the force transmission within the brake booster 200 and the hydraulic pressure generation by means of the brake cylinder 300 are known to the person skilled in the art and do not require further explanation here.

As already stated, the housing 160 can be loaded with an electromechanically generated second actuating force. In the depiction of FIG. 1, the force loading takes place by means of an actuating unit 170. The actuating unit 170 may be configured for example as a toothed sleeve which at least partially surrounds the housing 160 along its outer periphery. The housing 160 is coupled to the actuating unit 170 such that a displacement of the actuating unit 170 in the brake application direction along the longitudinal axis L also in each case leads to a displacement of the housing 160 in the brake application direction along the longitudinal axis L. In the embodiment shown in FIG. 1, in a rest position of the brake booster, the longitudinal axis L designates the longitudinal axis of the actuating member 120, the longitudinal axis of the output element 150, the longitudinal axis of the housing 160, and also the longitudinal axis of the actuating unit 170. In other words, these longitudinal axes run coaxially to each other.

To generate the second actuating force, the brake booster 200 comprises, as well as the assembly 100, an electrically actuatable electric motor 210 and a gear mechanism 220. The electric motor 210 and the gear mechanism 220 are configured to electromechanically generate the second actuating force which can be applied alternatively or additionally to the first actuating force on the brake cylinder 300 to execute or support a braking process.

The second actuating force may be determined using the actuation travel exerted by the driver on the brake pedal and/or the first actuating force generated by the driver, for example by means of a travel sensor coupled to the brake pedal or the actuating member 120, or by measurement of the brake pressure generated in the brake cylinder 300 by the driver, which is detected by sensors and in some cases plausibility-checked. Alternatively, the deceleration request and hence the actuating force to be applied by means of the brake booster 200 may also be initiated by a system for autonomous or partially autonomous driving, so no actuating force from the actual driver is required.

The vehicle braking system 1000 may be operated both in an autonomous and in a partially autonomous driving mode. In an autonomous or partially autonomous driving mode, the actuating force acting on the brake cylinder 300 is generated solely by the electric motor 210 and the gear mechanism 220, without the driver needing to actuate the brake pedal (there is therefore no force amplification in the true sense). In a conventional driving mode, the actuating force acting on the brake cylinder 300 corresponds to the sum of the first actuating force applied by the driver and the second (amplifying) actuating force applied by the brake booster 200.

Because of unevenness in the road surface or jerky actuation of the brake pedal during emergency braking for example, vibrations can arise in the assembly 100. In particular when the housing 160 is rigidly coupled to the actuating member 120, these vibrations can lead to an angular deflection (“kinking”) of the output element 150 relative to the housing 160. The longitudinal axis of the output element 150 and the longitudinal axis of the housing 160 in this case no longer align with each other. The “kinking” of the output element 150 may lead to an uneven, in particular unilateral distribution of the first and second actuating force on the transmission element 140 arranged between the output element 150 and the housing 160. This uneven distribution of the actuating force may in turn lead to an overload of and damage to the transmission element 140.

The angular deflection of the output element 150 according to the present disclosure may be prevented by means of a support 180 for a portion of the output element 150. The support 180 is here arranged, in the exemplary embodiment shown in FIG. 1, on an end face 164 of the housing facing the brake cylinder 300.

According to FIG. 1, the support 180 is configured as a circular metal disc which is welded to the housing 160 in the region of a flange-like diameter widening.

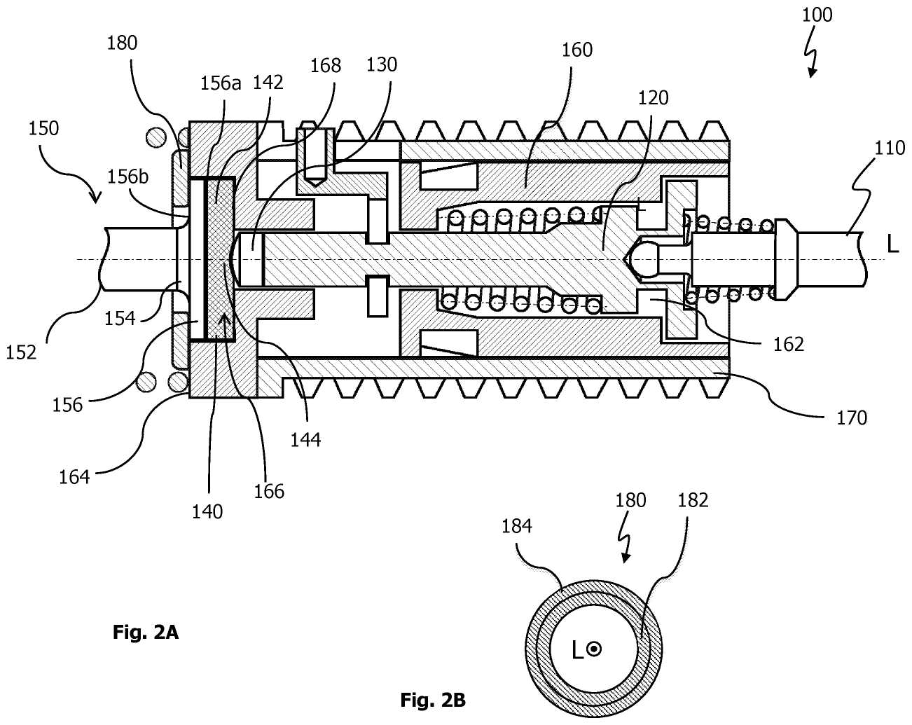

The further configuration of the support 180 is described in more detail below with reference to FIGS. 2A and 2B.

FIG. 2A substantially shows the assembly 100 already depicted in FIG. 1 with a support 180 according to an embodiment similar to that of FIG. 1. The same components carry the same reference signs as in FIG. 1. In FIG. 2A, in a rest position of the brake booster 200, the longitudinal axis L again corresponds to the longitudinal axis of the actuating member 120, the longitudinal axis of the output element 150, and also the longitudinal axis of the housing 160.

By deviation from FIG. 1, in the assembly 100 shown in FIG. 2A, a sensor carrier (without reference sign) is rigidly coupled to the actuating member 120. The sensor carrier comprises a portion protruding from the housing 160 on which a travel sensor is attached. The travel covered by the actuating member 120 as detected by said sensor is used in a control unit to calculate the amplification force to be applied.

As evident from FIG. 2A, the output element 150 is formed as a piston and comprises a shaft 152, a transitional region 154 and a head 156. The shaft 152 extends from the housing 160 and has a smaller diameter than the head 156. The head 156 is formed on an end of the shaft 152 facing the housing 160. The transitional region 154 is arranged between the shaft 152 and the head 156, wherein a diameter of the output element 150 in the region of the transitional region 154 increases steplessly from the shaft 152 to the head 156.

In the depiction of FIG. 2A, a cylindrical recess 166 is formed in an end face 164 of the housing opposite the actuating member 120. The recess 166 receives both the transmission element 140 and the head 156 of the output element 150. An end face 156a of the head 156 facing the actuating member 120 is loosely in contact with the transmission element 140.

As already explained above in connection with FIG. 1, the disc-like transmission element 140 is configured to receive the first and/or second actuating force and transmit this to the output element 150. To this end, the transmission element 150 has a radially outer region 142 and a radially inner region 144 relative to the longitudinal axis L. In the depiction of FIG. 2A, the radially outer region 142 of the transmission element 140 is in contact with a circular shoulder 168 of the housing 160. The radially inner region 144 of the output element 140 is in contact with the sensing disc 134 for receiving the first actuating force.

An end face 156b of the head 156 facing away from the actuating member 120 forms the supported or supportable portion of the output element 150 in the illustration of FIG. 2A. For this, the end face 156b cooperates with the support 180, as will be described in more detail below with reference to FIG. 2B.

FIG. 2B shows a top view in a brake application direction (along the longitudinal axis L) of the support 180 according to the present embodiment (similar to that of FIG. 1). In the depiction of FIG. 2B, the support 180 is formed by a separate support component and in the brake application direction comprises a circular support face 182 for the output element 150. The supported or supportable portion of the output element 150 may be brought into contact with the support face 182 during the above-described process of transmitting the first and/or second actuating force. Because of the circular form of the support face 182, the support 180 overlaps with the supported or supportable portion of the output element 150 (here, the rear side 156b of the cylindrical head 156 facing the brake piston 300) along its complete outer periphery. The support 180 may accordingly generate a support force acting evenly on the output element 150 against the brake application direction. This support force counters an angular deflection of the output element 150 relative to the longitudinal axis L, which may be provoked for example by vibrations transmitted to the housing 160. In other words, the support 180 supports the output element 150 such that when the supported portion of the output element 150 rests on the support 180 (i.e. in the supported state), the longitudinal axis of the output element 150 and the longitudinal axis of the housing 160 are oriented substantially coaxially to each other.

Because of the support 180 and the resulting corresponding orientation of the output element 150, force is transmitted from the actuating member 120 and the housing 160 onto the output element 150 substantially only parallel to the longitudinal axis L. A force transmission or deflection of the components of the assembly 100 at an angle relative to the longitudinal axis L is prevented by the support 180. In particular, the force is transmitted by means of the transmission element 140 only parallel to the longitudinal axis L. In other words, when the supported or supportable portion of the output element 150 cooperates with the support 180, the transmission element 140 deforms substantially evenly over its entire extent perpendicular to the longitudinal axis L. An uneven loading, in particular an overloading, of the force transmission element 140 during operation of the brake booster 200 is prevented by the proposed support 180, since the output element 150 can no longer “kink” with respect to the transmission element 140 and thereby overly squeeze this. As a result, the wear and risk of damage on the transmission element 140 are reduced.

As FIG. 2B shows, the support 180 comprises not only the circular support face 182 but also a circular fixing face 184 which is arranged radially outside the support face 182. By means of the fixing face 184, the support 180 may be attached to the housing. For example, a weld connection may be provided between the fixing face 184 and the end face 164 of the housing 160. For example, the weld connection is created by an ultrasound welding process.

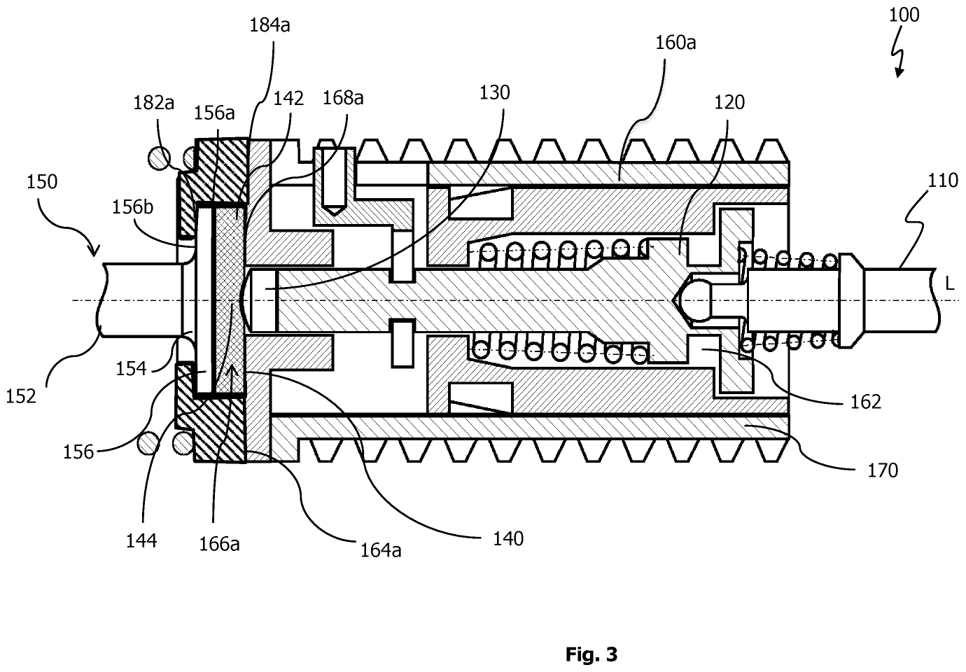

In the depiction of FIG. 2A, the support 180 is arranged on the housing 160 such that it at least partially covers the recess 166 of the housing 160. The recess 166 of the housing 160 is accordingly delimited firstly by the housing 160 and secondly by the support 180. An alternative embodiment of the support 180 is explained below with reference to FIG. 3.

FIG. 3 shows the assembly 100 according to FIG. 2A, wherein identical components carry identical reference signs.

In contrast to FIG. 2A, the housing 160a according to the embodiment of FIG. 3 does not comprise the recess 166. Instead, the end face 164a is formed level with the shoulder 168a of the housing 160a. The transmission element 140 and the head 156 of the output element 150 are arranged outside the housing 160 in the illustration of FIG. 3. Furthermore, the support face 182a is arranged offset in the brake application direction relative to the fixing face 184a of the support 180a.

According to the illustration in FIG. 3, the support 180a together with the end face 164a of the housing 160a also forms a receiver 166a, wherein in this embodiment the support 180a engages behind the head 156 and the transmission element 140.

The solutions disclosed herein reduce or prevent firstly the angular deflection (“kinking”) of the output element 150 relative to a longitudinal axis L of the housing 160, 160a. This guarantees that the first and/or second actuating force applied by the actuating member 120 and the housing 160, 160a are transmitted to the brake cylinder substantially completely parallel along a common longitudinal axis L of the housing 160, 160a and the brake cylinder 300. The occurrence of force components at a greater angle relative to the longitudinal axis L is avoided. Since these angular force components cannot be transmitted or not completely transmitted to the brake cylinder 300, a brake force loss resulting therefrom is also countered.

Also, according to the present disclosure, a unilateral load provoked by an uneven force transmission, in particular an overload (e.g. uneven squeezing) of the transmission element 140, is prevented by the support 180 which is rigidly arranged on the housing 160. The wear and hence the risk of damage to the transmission element 140 are accordingly reduced in the assembly 100 disclosed, in comparison with assemblies known from the prior art for electromechanical brake boosters. The service life of the assembly 100 and brake booster 200 is thereby extended.

1. An assembly (100) for an electromechanical brake booster (200) of a vehicle braking system (1000), comprising:
an actuating member (120) which can be loaded with a first actuating force generated by means of a brake pedal;
a housing (160, 160a) in which the actuating member (120) is received, wherein the housing (160, 160a) can be loaded with a second actuating force generated electromechanically;
an output element (150) extending away from the housing (160, 160a) and configured for transmitting the first and second actuating forces to a brake cylinder (300) of the vehicle braking system (1000);
an elastically deformable transmission element (140) which is arranged to transmit force in a brake application direction between the actuating member (120) and the housing (160, 160a) on one side and the output element (150) on the other, and is configured to receive the first actuating force from the actuating member (120) and the second actuating force from the housing (160, 160a) and transmit these to the output element (150); and
a support (160, 160a) that is rigidly arranged on the housing is provided for a portion of the output element (150), wherein the supported or supportable portion of the output element (150) is arranged between the support (180, 180a) on one side and the transmission element (140) on the other.

2. The assembly (100) as claimed in claim 1, wherein
the support (180, 180a) has an inner face (182, 182a) arranged against the brake application direction and configured to be or come into contact with the supported or supportable portion of the output element (150).

3. The assembly (100) as claimed in claim 1, wherein
the support in any case is formed partially by a separate support component (180, 180a) which is attached to the housing (160, 160a).

4. The assembly (100) as claimed in claim 3, wherein
the support component (180, 180a) is attached to the housing (160, 160a) by means of welding, in particular by means of ultrasound welding.

5. The assembly (100) as claimed in claim 1, wherein
the support (180, 180a) at least partially forms the limit of a receiver (166) which receives the supported or supportable portion of the output element (150) and the transmission element (140).

6. The assembly (100) as claimed in claim 1, wherein
the output element (150) comprises a shaft (152) and a head (156) which has a greater diameter than the shaft (152) and is formed on an end of the shaft (152) facing the housing (160, 160a), wherein the supported or supportable portion is formed on the head (156).

7. The assembly (100) as claimed in claim 5, wherein
the head (156) is received at least in portions in the receiver (166).

8. The assembly (100) as claimed in claims 6, wherein
the support (180, 180a) may cooperate with a portion of the head (156b) of the output element (150) facing away from the transmission element (140).

9. The assembly (100) as claimed in claim 1, wherein
the support (180, 180a) is configured to support the output element (150) such that in the supported state, a longitudinal axis (L) of the output element (150) and a longitudinal axis (L) of the housing (160, 160a) are oriented substantially parallel and in particular coaxial to each other.

10. The assembly (100) as claimed in claim 9, wherein
the support (180, 180a) is configured to support the output element (150) such that in the supported state, the elastically deformable transmission element (140) is deformed substantially evenly over its extent perpendicular to the longitudinal axis (L) of the housing (160, 160a).

11. The assembly (100) as claimed claim 1, wherein
the support (180, 180a) defines a circular support face (182, 182a) for the output element (150).

12. An electromechanical brake booster (200) for a vehicle braking system (1000), comprising
the assembly (100) as claimed in claim 1, and
an electric motor (210) and a gear mechanism (220) for loading the housing (160, 160a) with the second actuating force.

13. A vehicle braking system (1000) comprising an assembly (100) as claimed in claim 1 or a brake booster (200) comprising the assembly (100) as claimed in claim 1 and an electric motor (210) and a gear mechanism (220) for loading the housing (160, 160a) with the second actuating force.

14. The vehicle braking system (1000) as claimed in claim 13, which is configured to be operated in an autonomous or partially autonomous driving mode.
